(19) United States
(12) Patent Application Publication
(10) Pub. No.: US 2012/0137823 A1
(43) Pub. Date: Jun. 7, 2012

(54) BRAKE PEDAL DEVICE

(75) Inventors: Eunsik Kim, Daegu (KR); Jeongseon Min, Hwaseong-si (KR); Yangrae Cho, Hwaseong-si (KR); Hojong Oh, Busan (KR); Donghwan Kim, Ulsan (KR); Okjin Kim, Ulsan (KR)

(73) Assignees: HYUNDAI MOTOR COMPANY, Seoul (KR); DONGHEE INDUSTRIAL CO., LTD., Ulsan Metropolitan City (KR); KIA MOTORS CORPORATION, Seoul (KR)

(21) Appl. No.: 13/227,228

(22) Filed: Sep. 7, 2011

(30) Foreign Application Priority Data
Dec. 6, 2010 (KR) 10-2010-0123866

(51) Int. Cl. G05G 1/30

(52) U.S. Cl. 74/560

(57) ABSTRACT

Provided is a brake pedal device that can effectively prevent a brake pedal from hurting a drive by forcibly rotating the brake pedal toward the front of the vehicle, away from the driver, when the brake pedal is pushed to driver by a car collision, with the brake pedal supported to the car body. The brake pedal device includes a brake pedal pivotably supported to a car body, and a pivot lever forcibly pivoting the brake pedal to the front of a vehicle, away from a driver, by forcibly pivoting by means of the car body in a collision.

### CROSS-REFERENCE TO RELATED APPLICATIONS

The present application claims priority to Korean Patent Application Number 10-2010-0123866 filed Dec. 6, 2010, the entire contents of which application is incorporated herein for all purposes by this reference.

### BACKGROUND OF INVENTION

1. Field of Invention

The present invention relates to a brake pedal device, and more particularly, to a brake pedal device that prevents a driver from being hurt by a brake pedal in a car collision.

2. Description of Related Art

In the related art, brake pedals in vehicles are pivotably mounted on the car body by a hinge, and as a driver operates the brake pedal, the operational force of the brake pedal is transmitted to a hydraulic brake power unit and brake hydraulic pressure is generated, and the brake hydraulic pressure is transmitted to the brake body on the wheel, thereby stopping the wheels.

As described above, in a car collision, with the brake pedal pivotably supported on the car body, the car body is pushed to the driver and the brake pedal on the car body is correspondingly pushed with the pushed car body to the driver and hits and hurts the driver's legs.

Various technologies of preventing a brake pedal from being pushed to the driver have been proposed in the related art to reduce or prevent hurt of the driver due to the brake pedal in a car collision.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a brake pedal device that can effectively prevent a brake pedal from hurting a driver by forcibly rotating the brake pedal toward the front of the vehicle, away from the driver, when the car body and the brake pedal are pushed to driver by a car collision, with the brake pedal supported to the car body.

An exemplary embodiment of the present invention provides a brake pedal device, which comprises a brake pedal pivotably supported to a car body, and a pivot lever forcibly pivoting the brake pedal to the front of a vehicle, away from a driver, by forcibly pivoting by means of the car body in a collision.

The brake pedal may be detachably mounted on a car body bracket by a brake pedal mounting bracket and the pivot lever may be pivotably mounted on the brake pedal mounting bracket to pivot by means of the car body bracket in a collision.

A hook-shaped arm integrally protrudes from the upper portion of the brake pedal and the pivot lever has one end extending to the car body bracket and the other end extending to be locked to the arm.

The pivot lever is mounted to the brake pedal mounting bracket to pivot about a hinge shaft, and the hinge shaft has a hinge shaft bolt passing through the brake pedal mounting bracket, a hinge shaft pipe where the pivot lever is fitted to be integrally fixed, a pin coupled to the hinge shaft pipe, a washer and a nut fitted on one end of the hinge shaft bolt, and a bushing where the hinge shaft bolt is inserted.

Cross holes are formed at the brake pedal mounting bracket, a plurality of grooves is circumferentially formed at the hinge shaft pipe, and a plurality of protrusions that is fitted in the grooves through the holes is formed at the pin.

The pin is made of plastic such that the protrusions break when an impact force above a predetermined magnitude is applied.

According to the exemplary embodiments of the present invention, it is possible to effectively prevent the brake pedal from hurting a driver by allowing the brake pedal to be forcibly rotated to the front of the vehicle, away from the driver, by the lever that pivots when the car body is pushed in a car collision. Further, it is possible to reduce the weight and cost of the vehicle due to the simple structure and it is advantageous in terms of layout. Furthermore, it is not required to decrease strength of the brake pedal to reduce hurt, such that it is possible to achieve sufficient strength of the pedal and prevent the driver from being hurt by forcibly rotating the brake pedal even under any types of front collisions.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a side view of a brake pedal device according to an exemplary embodiment of the present invention.

FIG. 2 is a view illustrating the operation of the brake pedal device according to an exemplary embodiment of the present invention in a car collision.

FIG. 3 is an exploded perspective view of a hinge shaft according to an exemplary embodiment of the present invention.

FIG. 4 is an exploded perspective view of the front end of the hinge shaft according to an exemplary embodiment of the present invention.

FIG. 5 is a cross-sectional view when the hinge shaft according to an exemplary embodiment of the present invention is fastened to a brake pedal mounting bracket.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention are described in detail with reference to the accompanying drawings.

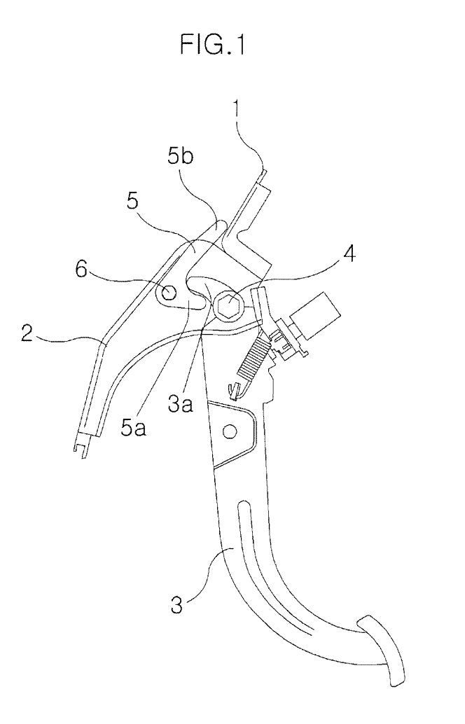

FIG. 1 shows a brake pedal device according to an exemplary embodiment of the present invention before a collision, in which a cowl bracket 1 is fixed to a car body and a brake pedal mounting bracket 2 is detachably fastened to cowl bracket 1.

A brake pedal 3 is mounted on brake pedal mounting bracket 2 to pivot about a hinge shaft 4.

A hook-shaped arm 3a that integrally operates with brake pedal 3 is disposed at the upper portion of brake pedal 3 received in brake pedal mounting bracket 2. One will appreciate that the hook-shaped arm and the brake pedal may be monolithically formed.

Hinge shaft 4 is disposed through the upper portion of the brake pedal and arm 3a such that brake pedal 3 and arm 3 can integrally pivot about hinge shaft 4.

A pivot lever 5 is mounted on brake pedal mounting bracket 2 to pivot about a hinge shaft 6 and bent in an L-shape with one end 5a locked to arm 3a and the other end 5b in contact with cowl bracket 1.

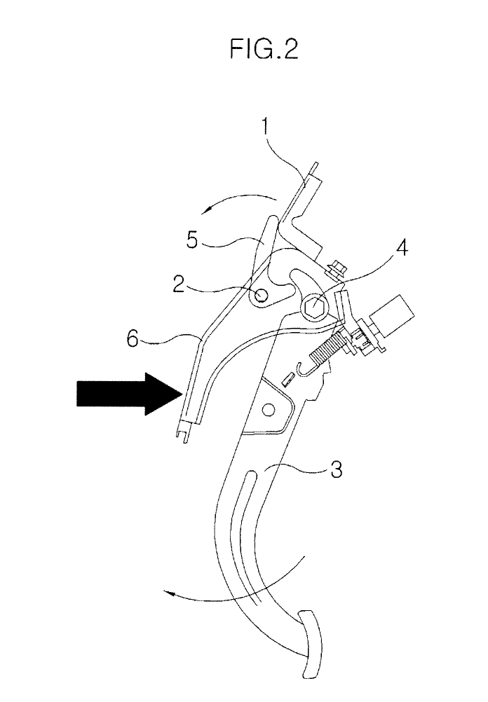

FIG. 2 illustrates the operation of the brake pedal device according to an exemplary embodiment of the present invention in a car collision, that is, the car body is pushed to a driver in a front collision of a vehicle, the impact force is transmitted to brake pedal mounting bracket 2, as indicated by an arrow in FIG. 2, and the brake pedal mounting bracket is detached from cowl bracket 1 by the transmitted impact force.

Further, pivot lever 5 pivots counterclockwise about hinge shaft 6 by cowl bracket 1, as indicated by an arrow, and arm 3a and brake pedal 3 pivot clockwise about hinge shaft 4 by the pivot of pivot lever 5. That is, brake pedal 3 pivots to the front of the vehicle, away from the driver, such that it is possible to effectively prevent brake pedal 3 from hurting the driver.

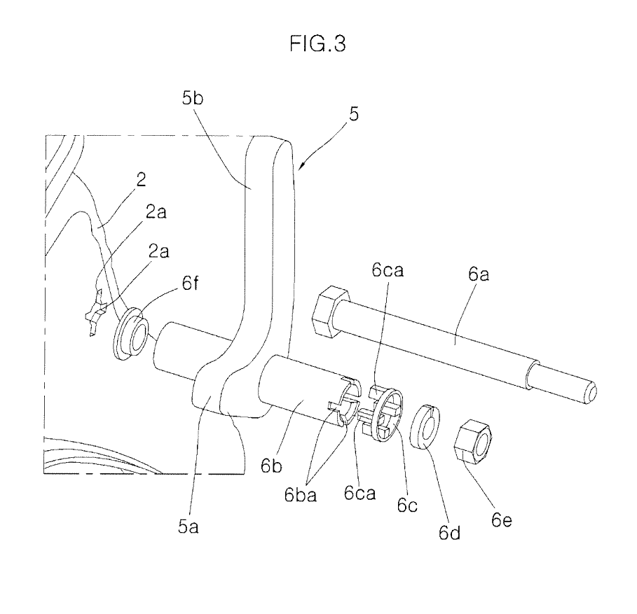

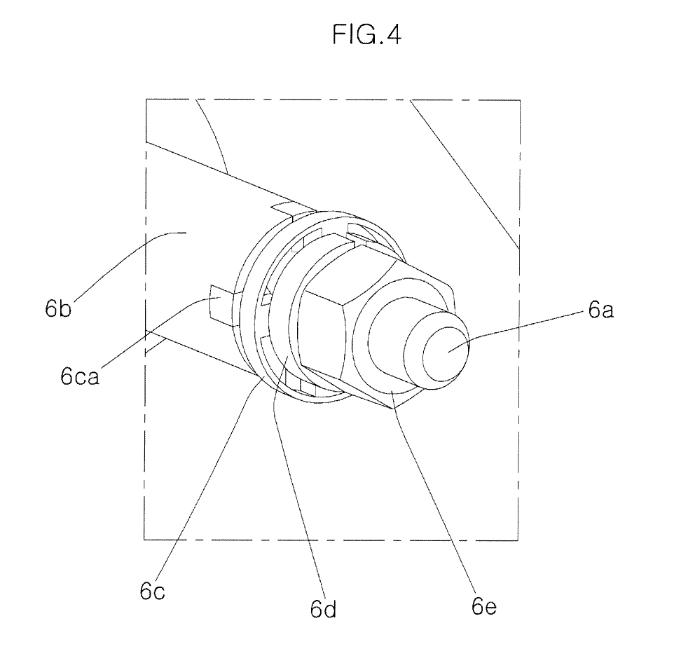

Hinge shaft 6 of pivot lever 5 is described with reference to FIGS. 3 to 5. Hinge shaft 6 is composed of a hinge shaft bolt 6a passing through brake pedal mounting bracket 2, a hinge shaft pipe 6b where pivot lever 5 is fitted to be integrally fixed, a pin 6c fitted in a groove 6ba formed in hinge shaft pipe 6b, a washer 6d and a nut 6e fitted on one end of hinge shaft bolt 6a, and a bushing 6f where hinge shaft bolt 6a is inserted. One will appreciate that the hinge shaft and pivot lever may be monolithically formed.

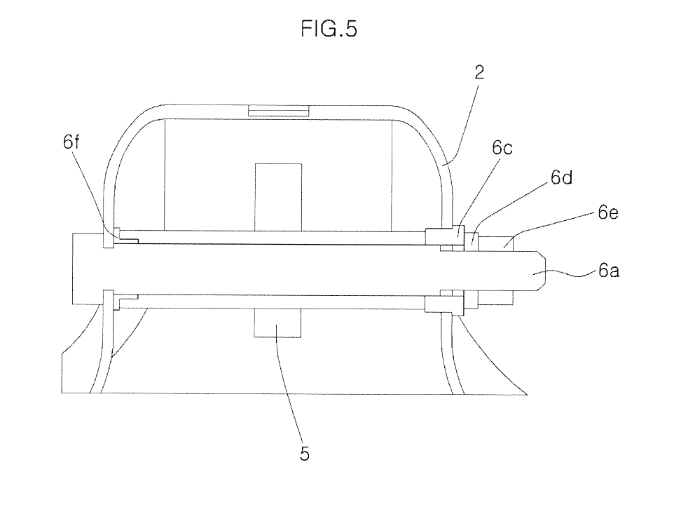

A plurality of cross holes 2a is formed at brake pedal mounting bracket 2 and a plurality of protrusions 6ca that is inserted in holes 2a are integrally radially formed at pin 6c. One will appreciate that the protrusions and the pin may be monolithically formed. Protrusions 6ca are inserted in grooves 6ba of hinge shaft pipe 6b, through holes 2a, as shown in detail in the cross-sectional view of FIG. 5.

Pin 6c may be made of plastic and breaks when an external force above a predetermined magnitude is applied. That is, when pivot lever 5 forcibly pivots by means of cowl bracket 1, hinge shaft pipe 6b of pivot lever 5 correspondingly pivots, and when the torque from hinge shaft pipe 6b is over a predetermined level, protrusions 6ca of pin 6c coupled to hinge shaft pipe 6b break, such that pivot lever 5 can pivot.

The shape, number, and material of pin 6c and protrusions 6ca may be variously selected, and for example, the pin may be formed in an a straight shape with a plurality of protrusions or a polygonal shape, and clips made of steel may be possible.

For convenience in explanation and accurate definition in the appended claims, the terms upper, front, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A brake pedal device comprising:
a brake pedal pivotably supported on a car body of a vehicle; and
a pivot lever forcibly pivoting the brake pedal toward a front of the vehicle, away from a driver, by the car body during a collision.

2. The brake pedal device as defined in claim 1, wherein the brake pedal is detachably mounted on a car body bracket by a brake pedal mounting bracket and the pivot lever is pivotably mounted on the brake pedal mounting bracket to pivot by the car body bracket during a collision.

3. The brake pedal device as defined in claim 2, wherein a hook-shaped arm integrally protrudes from the upper portion of the brake pedal and the pivot lever has one end extending to the car body bracket and the other end extending to be locked to the arm.

4. The brake pedal device as defined in claim 1, wherein the pivot lever is mounted to the brake pedal mounting bracket to pivot about a hinge shaft, the hinge shaft has a hinge shaft bolt passing through the brake pedal mounting bracket, a hinge shaft pipe where the pivot lever is fitted to be integrally fixed, and a pin coupled to the hinge shaft pipe, and the pin breaks when an impact force above a predetermined magnitude is applied such that the pivot lever forcibly rotates the brake pedal.

5. The brake pedal device as defined in claim 4, wherein a washer and a nut are fitted on one end of the hinge shaft bolt and a bushing is fitted on the other end of the hinge shaft bolt.

6. The brake pedal device as defined in claim 4, wherein cross holes are formed at the brake pedal mounting bracket, a plurality of grooves are circumferentially formed at the hinge shaft pipe, and a plurality of protrusions that are fitted in the grooves through the holes are formed at the pin.

7. The brake pedal device as defined in claim 4, wherein the pin is made of plastic such that the protrusions break when an impact force is above a predetermined magnitude.
